(19) United States
(12) Patent Application Publication
(10) Pub. No.: US 2024/0422321 A1
(43) Pub. Date: Dec. 19, 2024

(54) METHOD AND APPARATUS FOR VIDEO CODING USING CONTEXT MODEL INITIALIZATION

(71) Applicants: HYUNDAI MOTOR COMPANY, SEOUL (KR); KIA CORPORATION, SEOUL (KR); DIGITALINSIGHTS INC., SEOUL (KR)

(72) Inventors: Yong Jo Ahn, Seoul (KR); Jong Seok Lee, Seoul (KR); Jin Heo, Yongin-si (KR); Seung Wook Park, Yongin-si (KR)

(73) Assignees: HYUNDAI MOTOR COMPANY, SEOUL (KR); KIA CORPORATION, SEOUL (KR); DIGITALINSIGHTS INC., SEOUL (KR)

(21) Appl. No.: 18/820,873

(22) Filed: Aug. 30, 2024

Related U.S. Application Data
(63) Continuation of application No. PCT/KR2023/002515, filed on Feb. 22, 2023.

(30) Foreign Application Priority Data
Mar. 21, 2022 (KR) 10-2022-0034710
Feb. 15, 2023 (KR) 10-2023-0020077

(51) Int. Cl. H04N 19/13; H04N 19/124; H04N 19/172; H04N 19/177; H04N 19/436; H04N 19/463

(52) U.S. Cl. CPC H04N 19/13; H04N 19/124; H04N 19/172; H04N 19/177; H04N 19/436; H04N 19/463

(57) ABSTRACT

A video coding method and an apparatus initialize a context model of Context-based Adaptive Binary Arithmetic Coding (CABAC) by using context information at a predetermined location in a previously reconstructed picture to increase video coding efficiency and enhance video quality. Or, the video coding method and the apparatus initialize a context model of CABAC by using context information at a predetermined location in a corresponding parallelization unit within the previously reconstructed picture.

### CROSS REFERENCE TO RELATED APPLICATIONS

This application is a continuation of International Application No. PCT/KR2023/002515 filed on Feb. 22, 2023, which claims priority to and the benefit of Korean Patent Application No. 10-2022-0034710 filed on Mar. 21, 2022, and Korean Patent Application No. 10-2023-0020077, filed on Feb. 15, 2023, the entire contents of each of which are incorporated herein by reference.

### TECHNICAL FIELD

The present disclosure relates to a video coding method and an apparatus using context model initialization.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

In video coding methods and devices, Context-based Adaptive Binary Arithmetic Coding (CABAC), a technique used in video compression standards such as H.264/AVC, H.265/HEVC, H.266/VVC, and the like, utilizes previously encoded and decoded statistical information to currently perform binary arithmetic coding. To improve the prediction performance of symbol probabilities, the context can utilize the statistical information defined by the previously encoded and decoded symbols. The compression performance of CABAC is affected by the context modeling method, and the higher the probability of the Most Probable Symbol (MPS) in the context model, the better the coding performance of the video coding method. Along with this factor, the initial probability value of the context model also affects the coding performance. Conventional video coding methods initialize the context model fixedly based on the quantization parameter. To improve the coding performance of CABAC, there is a need to provide an efficient method for initial value setting for the context model.

### SUMMARY

The present disclosure seeks to provide a video coding method and an apparatus for initializing a context model of Context-based Adaptive Binary Arithmetic Coding (CABAC) by using context information at a predetermined location in a previously reconstructed picture to increase video coding efficiency and enhance video quality. Or the video coding method and the apparatus initialize a context model of CABAC by using context information at a predetermined location in a corresponding parallelization unit within the previously reconstructed picture.

At least one aspect of the present disclosure provides a method performed by a video decoding device for initializing a context model of a context-based adaptive binary arithmetic coding. The method includes decoding, from a bitstream, context initialization-enabling information that indicates whether to use a reference-based context initialization method for the context model in a current processing unit in a current picture. The method also includes determining an initialization method of the context model by using the context initialization-enabling information between the reference-based context initialization method and a quantization parameter-based context initialization method. The method also includes checking whether the initialization method is the reference-based context initialization method. When the initialization method is the reference-based context initialization method, the method also includes, initializing the context model in the current processing unit by using a context state at a predetermined location in a previously reconstructed reference picture.

Another aspect of the present disclosure provides a method performed by a video encoding device for initializing a context model of a context-based adaptive binary arithmetic coding. The method includes determining an optimum initialization method of the context model by applying initialization methods of the context model to a current processing unit in a current picture. Here, the initialization methods include a reference-based context initialization method and a quantization parameter-based context initialization method. The method also includes setting, based on the optimum initialization method, context initialization-enabling information that indicates whether the reference-based context initialization method is to be used for the context mode. The method also includes encoding the context initialization-enabling information. When the reference-based context initialization method is to be used, the method further includes initializing the context model in the current processing unit by using a context state at a predetermined location in a previously reconstructed picture.

Yet another aspect of the present disclosure provides a computer-readable recording medium storing a bitstream generated by a video encoding method for initializing a context model. The video encoding method includes determining an optimum initialization method of the context model by applying initialization methods of the context model of a context-based adaptive binary arithmetic coding to a current processing unit in a current picture. Here, the initialization methods include a reference-based context initialization method and a quantization parameter-based context initialization method. The video encoding method also includes setting, based on the optimum initialization method, context initialization-enabling information that indicates whether the reference-based context initialization method is to be used for the context mode. The video encoding method also includes encoding the context initialization-enabling information. When the reference-based context initialization method is to be used, The video encoding method further includes initializing the context model in the current processing unit by using a context state at a predetermined location in a previously reconstructed picture.

As described above, the present disclosure provides a video coding method and an apparatus for initializing the context model of CABAC by using context information at a predetermined location in a previously reconstructed picture, or a predetermined location in a corresponding parallelization unit within a previously reconstructed picture. Thus, the video coding method and the apparatus eliminate the context model's dependence on the initialization to improve the performance of parallel processing during coding and to effectively reduce the degradation in coding efficiency that occurs in parallel processing.

### BRIEF DESCRIPTION OF THE FIGURES

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a block diagram of a context model initialization device, according to at least one embodiment of the present disclosure.

FIG. 7 is a diagram illustrating the concept of a picture-wise context initialization method among reference-based context initialization methods, according to at least one embodiment of the present disclosure.

FIG. 8 is a diagram illustrating the concept of a slice-wise or tile-wise context initialization method, according to at least one embodiment of the present disclosure.

FIG. 9 is a diagram illustrating the initialization of a context model in the parallel processing of WPP.

FIGS. 10 and 11 are diagrams illustrating the concept of a context initialization method with paralleling of WPP applied, according to at least one embodiment of the present disclosure.

FIG. 12 is a diagram illustrating the concept of a context initialization method with VPDUs applied, according to at least one embodiment of the present disclosure.

FIG. 13 is a diagram illustrating a reference structure of reference pictures, according to at least one embodiment of the present disclosure.

FIG. 14 is a flowchart of a method performed by a video encoding device for initializing a context model of a CABAC, according to at least one embodiment of the present disclosure.

FIG. 15 is a flowchart of a method performed by a video decoding device for initializing a context model of CABAC, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

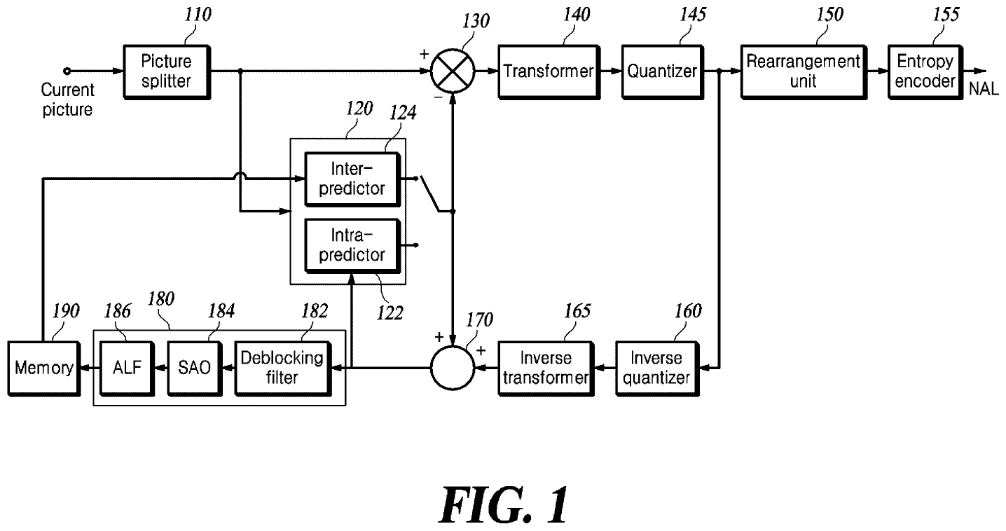

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

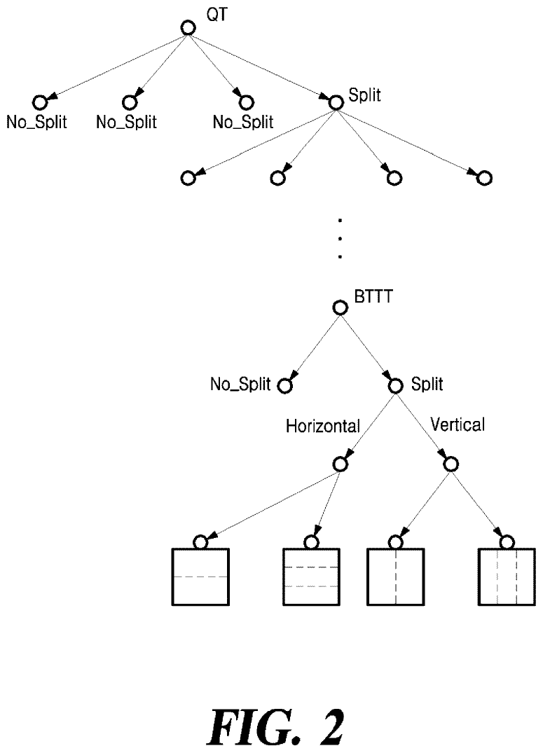

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

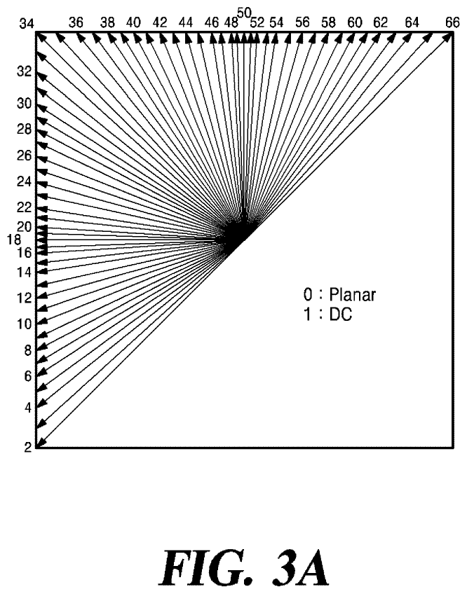

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

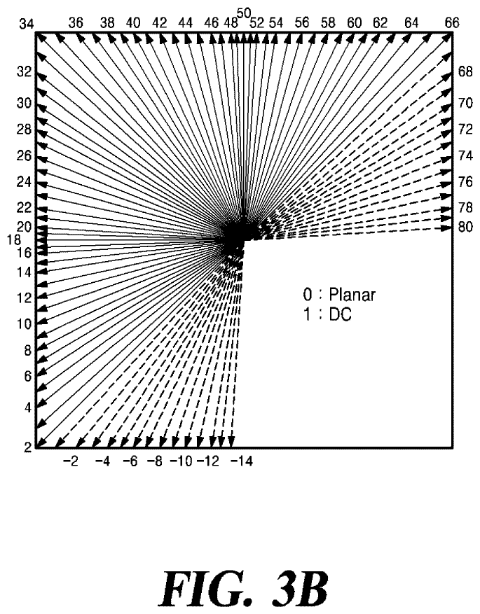

As a neighboring block for deriving the merge candidate, all or some of a left block AG, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block AG, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

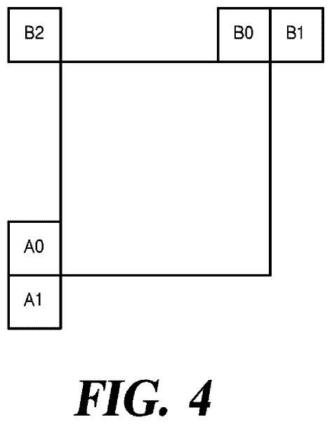

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus for initializing a context model of Context-based Adaptive Binary Arithmetic Coding (CABAC) by using context information at a predetermined location in a previously reconstructed picture to increase video coding efficiency and enhance video quality. Or the video coding method and the apparatus initialize a context model of CABAC by using context information at a predetermined location in a corresponding parallelization unit within the previously reconstructed picture.

The following embodiments may be performed by the entropy encoder 155 in the video encoding device. The following embodiments may also be performed by the entropy decoder 510 in the video decoding device.

The video encoding device in the encoding of the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the embodiments of the present disclosure.

In the following description, the term “target block” may be used interchangeably with the current block or coding unit (CU). The term “target block” may refer to some region of the coding unit.

Further, the value of one flag being true indicates when the flag is set to 1. Additionally, the value of one flag being false indicates when the flag is set to 0.

Hereinafter, context, and context model are used in CABAC.

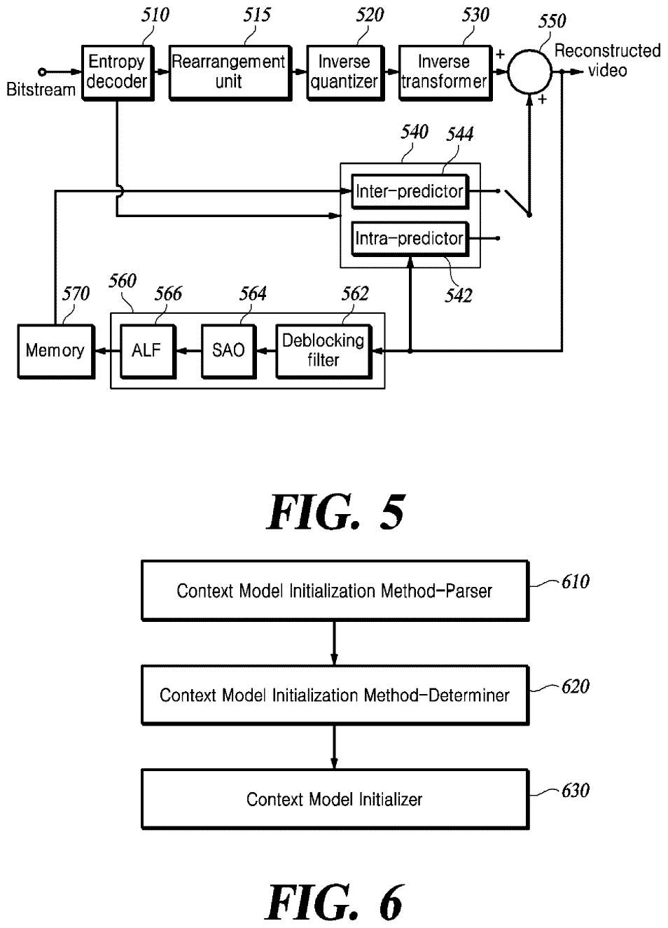

FIG. 6 is a block diagram of a context model initialization device, according to at least one embodiment of the present disclosure.

A context model initialization device for CABAC according to at least one embodiment performs a reference-based context initialization method or a conventional quantization parameter-based (QP-based) context initialization method. The context model initialization device includes all or part of a context model initialization method-parser 610 (hereinafter referred to as the ‘initialization method-parser), a context model initialization method-determiner 620 (hereinafter referred to as the ‘initialization method-determiner), and a context model initializer 630 (hereinafter referred to as the ‘initializer’).

The following description focuses on the context model initialization device in the video decoding device, but the context model initialization device may be equally applicable to the video encoding device.

The initialization method-parser 610 parses information indicating whether or not to use at least one context initialization method of the one or more context initialization methods. The information is called hereinafter ‘context initialization-enabling information’.

In this case, the context initialization-enabling information is provided by the present disclosure as information that indicates whether to use the reference-based context initialization to initialize the context. This information may be represented as a flag, or an index specifying one of a plurality of context model initialization methods. Further, the context initialization-enabling information for CABAC may be signaled by using at least one or more high-level syntaxes. In one embodiment, the context initialization-enabling information may be transmitted in at least one or more of a video parameter set (VPS), a sequence parameter set (SPS), a picture parameter set (PPS), and a slice header. Additionally, if the current picture or reference picture is partitioned into specific parallelization units, e.g., slices, tiles, CTU lines, or Virtual Pipeline Data Units (VPDUs), the context initialization-enabling information may be sent for each of those parallelization units.

The initialization method-determiner 620 determines whether to use reference-based context initialization by using the context initialization-enabling information obtained by the initialization method-parser 610. Further, the initializing method-determiner 620 may determine a context model initialization method based on whether to use reference-based context initialization.

The initialization method-determiner 620 may determine the initialization method according to whether or not the reference-based context initialization is to be used as follows. If the context initialization-enabling information indicates the use of the reference-based context initialization, the reference-based context initialization method is selected. If the context initialization-enabling information does not indicate the use of the reference-based context initialization, the QP-based context initialization method is selected.

In one example, the context initialization-enabling information may be in the form of a flag. If the flag is true, the context model initialization device may use the reference-based context initialization method. On the other hand, if the flag is false, the context model initialization device may use the QP-based context initialization method.

As another example, the context initialization-enabling information may be in the form of an index that indicates one of a plurality of context model initialization methods. If the index is zero, the context model initialization device may use the QP-based context initialization method. If the index is non-zero, the context model initialization device may use the reference-based context initialization method indicated by the index.

The initializer 630 performs context initialization according to the initialization method determined by the initialization method-determiner 620. In this case, when the reference-based context initialization method is used as provided by the present disclosure, the initializer 630 performs the context initialization by setting the context state at the predetermined location, which is stored in the previous decoding step to be the current context. Here, the context state stored in the previous decoding step represents the state of the CABAC context stored at a specified position in the previously decoded picture according to the decoding sequence. If the current picture or previously decoded picture is partitioned into specific parallelization units, e.g., slices, tiles, CTU lines, or VPDUs, the stored context state represents the state of the CABAC context stored at a specified position of those corresponding parallelization units in the previously decoded picture. The specified position of the parallelization unit is described further below.

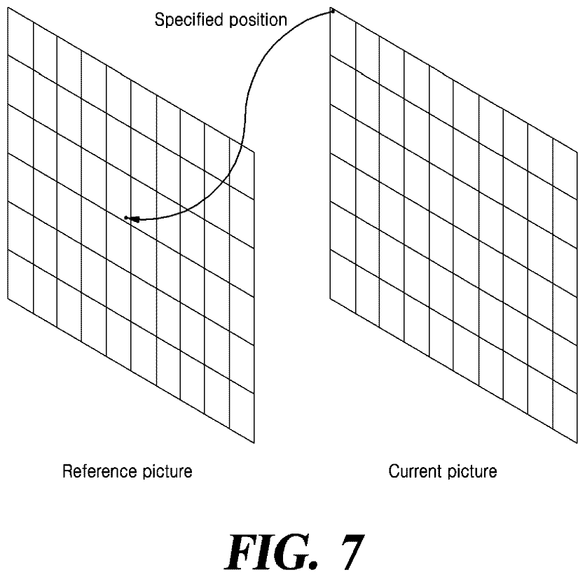

FIG. 7 is a diagram illustrating the concept of a picture-wise context initialization method among reference-based context initialization methods, according to at least one embodiment of the present disclosure.

In the example of FIG. 7, the context model initialization device initializes a context model for the current picture by referencing a CABAC context state stored at a specified position in a previously decoded reference picture. In this case, the specified position of the previously decoded reference picture represents a predetermined absolute position in video decoding or a relative position to the position where to perform the current decoding. When the specified position information is the equally predetermined position by the video encoding device and the video decoding device, the specified position information may not be separately signaled from the video encoding device to the video decoding device. However, if such position information is determined in terms of optimizing rate distortion during the encoding process, the video encoding device may signal such position information to the video decoding device.

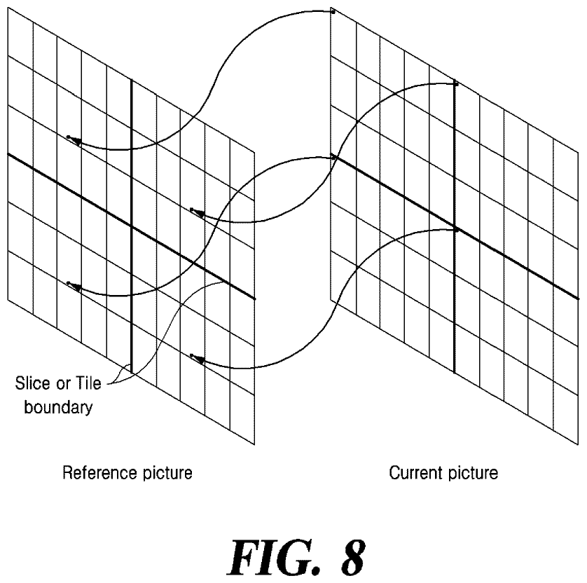

FIG. 8 is a diagram illustrating the concept of a slice-wise or tile-wise context initialization method, according to at least one embodiment of the present disclosure.

In the example of FIG. 8, the context model initialization device may refer to a CABAC context state stored at a specified location of a previously decoded reference picture. In this case, when decoding is performed by partitioning a single picture into multiple parallelization units, as in the example of FIG. 8, the context model initialization device may perform reference-based context initialization for each parallelization unit to ensure parallelism.

As illustrated in the example of FIG. 8, to perform reference-based context initialization per parallelization unit, the context model initialization device makes reference to the CABAC context state stored at a specified position of each parallelization unit in the previously decoded reference picture to initialize the context model in the corresponding parallelization unit in the current picture. The above-described parallelization units may be slices or tiles, as exemplified in FIG. 8.

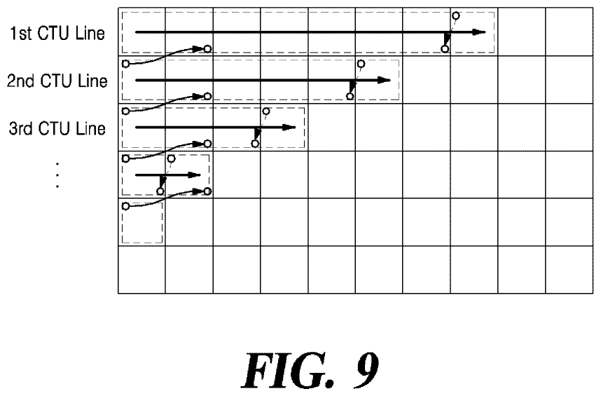

Referring now to FIGS. 9 to 11, a context initialization method is described for a case where paralleling of wave-front parallel processing (WPP) is applied.

WPP performs parallel encoding and decoding in CTU-line units. With conventional parallel processing of WPP as illustrated in FIG. 9, the context model is initialized in CTU-line units. In the first CTU line, the context model is initialized with a predetermined, fixed CABAC context state value. As mentioned above, the fixed CABAC context state value may be derived on a QP basis. From the second CTU line onwards, the context model is initialized by using the CABAC context state value at a predetermined specified position of the previous CTU line. Based on this initialization scheme, conventional parallel processing of WPP can preserve the encoding performance and compensate for the degradation of encoding performance due to the parallel processing.

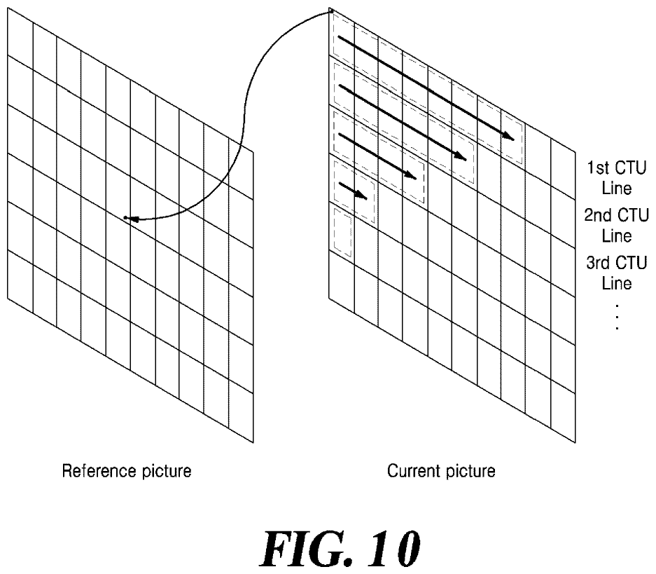

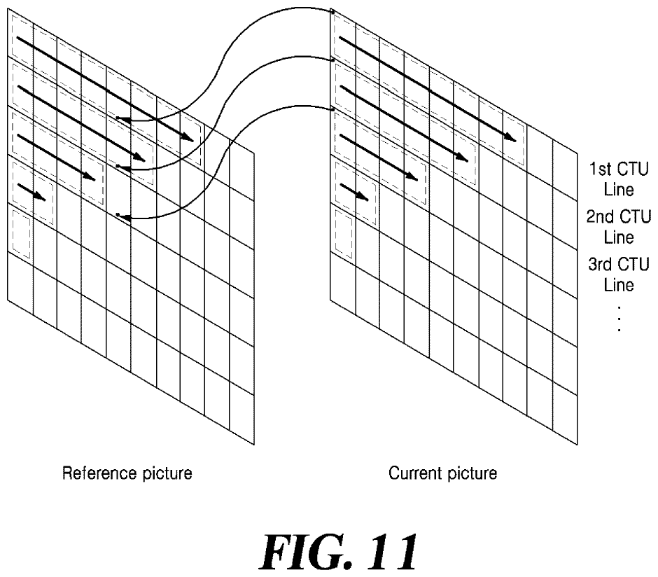

FIGS. 10 and 11 are diagrams illustrating the concept of a context initialization method with paralleling of WPP applied, according to at least one embodiment of the present disclosure.

When reference-based context initialization is performed with paralleling of WPP applied, as illustrated in FIG. 10, the context model initialization device makes reference to a CABAC context model state stored at a specified position of a previously decoded reference picture to initialize a CABAC context model in the first CTU of the current picture. Then, the context model initialization device may use the CABAC context state of the predetermined specified position of the previous CTU line to initialize the CABAC context model in the first CTU of the subsequent CTU lines, such as the second CTU line, the third CTU line, and the like.

At this time, the specified position of the previously decoded reference picture indicates a predetermined absolute position in the video decoding or a relative position to the position where to perform the current decoding. When the specified position information is the equally predetermined position by the video encoding device and the video decoding device, the specified position information may not be separately signaled from the video encoding device to the video decoding device. However, if such position information is determined in terms of optimizing rate distortion during the encoding process, the video encoding device may signal such position information to the video decoding device.

In another embodiment, when parallel processing of WPP is performed, the context model initialization device may perform reference-based context initialization for the first CTU line, and each of the subsequent CTU lines. The context model initialization device initializes the context model in the corresponding CTU line of the current picture by referring to the CABAC context state stored at a predetermined specified position per CTU line in the reference picture corresponding to each CTU line, as shown in the example of FIG. 11.

Meanwhile, VPDU (Virtual Pipeline Data Unit) is a parallel data processing unit proposed by VVC to reduce the implementation complexity of hardware with increasingly larger CTU sizes. Multiple VPDUs are defined within one CTU. By processing the actual decoding operation in VPDU units, the size of the hardware and thus the implementation complexity can be reduced.

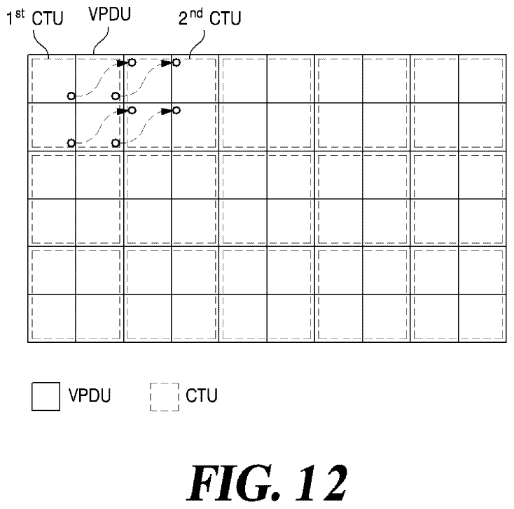

FIG. 12 is a diagram illustrating the concept of a context initialization method with VPDUs applied, according to at least one embodiment of the present disclosure.

When VPDUs are used to sequentially perform the entropy coding process of each VPDU, it is typical to use the CABAC context state stored in the last CU of the first VPDU to initialize the context of the first CU of the second VPDU. Similarly, the CABAC context state stored in the last CU of the second VPDU may be used to initialize the context of the first CU of the third VPDU.

When reference-based context initialization is performed with VPDU-based paralleling applied, as illustrated in FIG. 12, the context model initialization device may reference the CABAC context states of the last CUs of the first CTU's corresponding first VPDU, second VPDU, third VPDU, and fourth VPDU to initialize the CABAC context model in the first CUs of the second CTU's first VPDU, second VPDU, third VPDU, and fourth VPDU.

As described above, by using the context model initialization method for CABAC according to the present embodiment, VPDU-based parallel processing may be enabled, and in this process, the context model's dependence on the initialization between adjacent VPDUs in the same CTU may be eliminated. Thus, the present disclosure may improve the performance of parallel processing and may avoid the degradation of coding efficiency that occurs in parallel processing.

On the other hand, when the context initialization-enabling information is an index, the context model initialization device may use the index to indicate one of the reference-based initialization methods described above for the current processing unit. Herein, the current processing unit may be the current picture or a parallelization unit within the current picture. The parallelization unit may be a slice, tile, CTU line, or VPDU within the current picture.

For example, when the current processing unit is a picture, and when an index is 1, the following reference-based initialization method may be used. The context model initialization device may use the context state at a predetermined location in a previously reconstructed reference picture to initialize the context model of the current picture.

As another example, when the current processing unit is a parallelization unit, and when an index is 2, the following reference-based initialization method may be utilized. The context model initialization device may use the context state at a predetermined location in the previously reconstructed reference picture to initialize the context model in the first parallelization unit in the current picture.

Further, when the current processing unit is a parallelization unit and when an index is 3, the following reference-based initialization method may be used. The context model initialization device may reference the context state stored at a specified position of the parallelization unit corresponding to the current processing unit in the previously reconstructed reference picture to initialize the context model in the current processing unit.

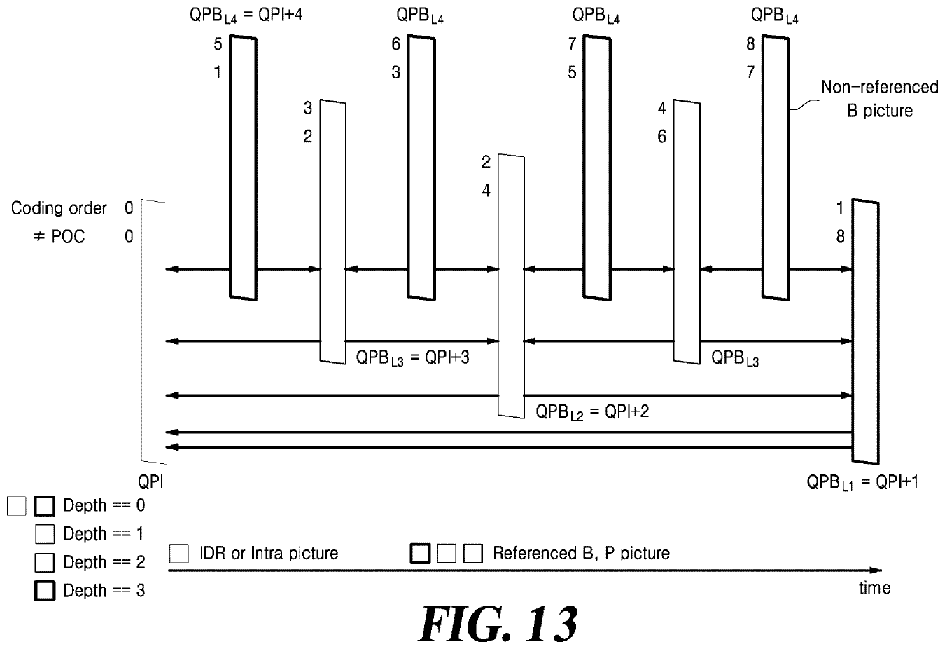

FIG. 13 is a diagram illustrating a reference structure of reference pictures, according to at least one embodiment of the present disclosure.

In performing video decoding, the video decoding device may decode pictures disposed over time, in a predetermined order. A random access video encoding scenario may be illustrated as in FIG. 13. To facilitate random position access to the video sequence and improve the coding efficiency, the random access is so determined to differentiate the encoding order from the temporal order to achieve a picture configuration that secures the encoding performance and function. At this time, compression performance can be improved by organizing one or more temporal layers according to the flow of time in consideration of human cognitive visual characteristics and configuring QP values differently for each temporal layer. Therefore, when the CABAC context model initialization is performed, the context model initialization device may select a picture to reference the CABAC context model by considering these temporal layers.

In the example of FIG. 13, depth represents a temporal layer. QPI denotes a quantization parameter for an intra picture, and QPB denotes a quantization parameter for a picture subject to inter prediction.

In performing reference-based context initialization according to embodiments, the context model initialization device may perform context initialization by referring to a CABAC context state value at a predetermined specified position of a previously decoded picture that is the most temporally proximate among the reference pictures located in the same temporal layer.

Further, in performing reference-based context initialization according to embodiments, the context model initialization device may operate differently depending on the reference structure of the group of pictures (GOP). In one embodiment, when the current GOP (the GOP containing the current picture) uses an open GOP that can reference a previous GOP, and if a picture with the same temporal layer as the current picture does not exist within the current GOP, a picture included in the previous GOP may be utilized among the previously decoded pictures. In other words, the context model initialization device may reference the CABAC context state value from a previously reconstructed picture that is included in the previous GOP and has the same temporal layer. Whereas, if the current GOP uses a closed GOP, where the current GOP cannot reference the previous GOP, then a picture contained in the previous GOP that has the same temporal layer as the current picture cannot be used as a reference picture for CABAC context reference.

At this point, upon detecting that the current picture is a non-reference picture entailing problems such as buffer management and reference dependency during subsequent decoding, the context model initialization device may not perform the reference-based context initialization method according to the present disclosure. Instead, the context model initialization device may initialize the context model by performing a conventional QP-based context initialization method.

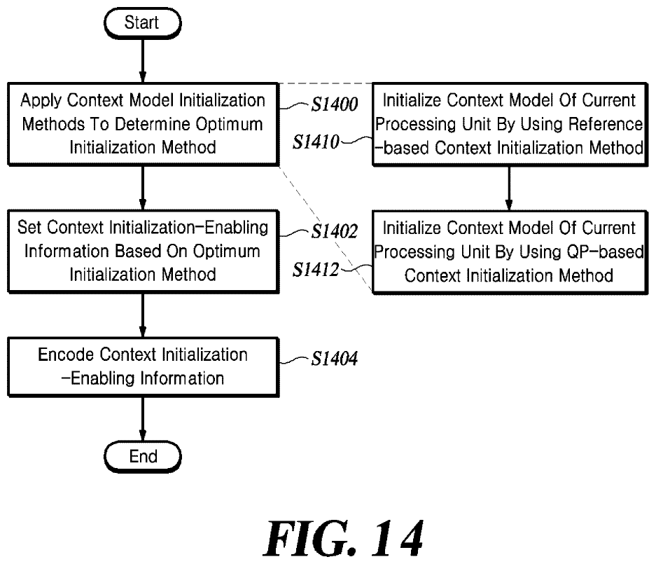

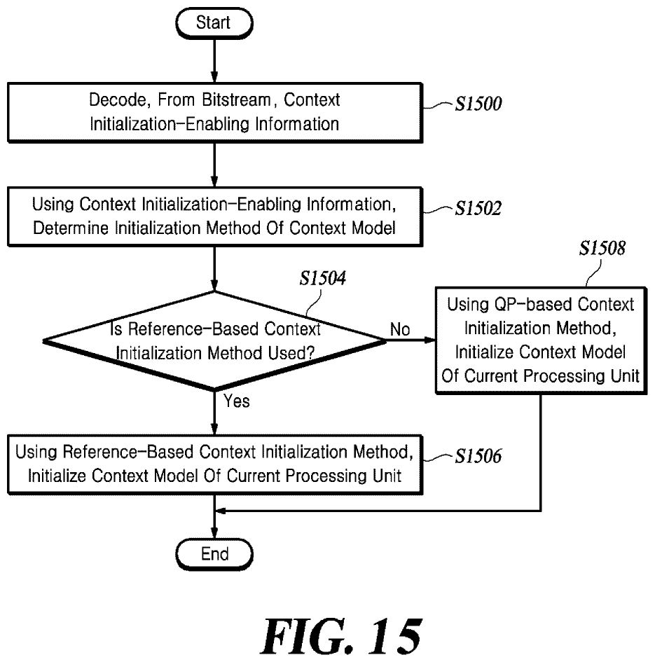

Referring now to FIGS. 14 and 15, methods of initializing a context model of a CABAC are described.

FIG. 14 is a flowchart of a method performed by the video encoding device for initializing a context model of a CABAC, according to at least one embodiment of the present disclosure.

The video encoding device applies the initialization methods of the context model in the CABAC to the current processing unit in the current picture to determine an optimum initialization method (S1400). Here, the initialization methods include a reference-based context initialization method and a QP-based context initialization method. The video encoding device may determine the optimum initialization method in terms of optimizing coding efficiency.

The determining of the optimum initialization method may include the following steps (S1410 and S1412).

The video encoding device initializes the context model in the current processing unit by using a reference-based context initialization method (S1410). The video encoding device may use a context state at a predetermined location in a previously reconstructed picture to initialize the context model in the current processing unit.

The video encoding device may initialize the context model in the current processing unit by using a QP-based context initialization method (S1412). The video encoding device may use a predetermined, quantization parameter-based context state to initialize the context model in the current processing unit.

The current processing unit may be the current picture or a parallelization unit within the current picture. The parallelization unit may be a slice, tile, CTU line, or VPDU within the current picture.

When the current processing unit is a picture and the initialization method is a reference-based context initialization method, the video encoding device may use the context state at a predetermined location in the previously reconstructed reference picture to initialize the context model of the current picture.

When the current processing unit is a parallelization unit and the initialization method is a reference-based context initialization method, the video encoding device may use the context state at a predetermined location in the previously reconstructed reference picture to initialize the context model in the first parallelization unit in the current picture.

Alternatively, when the current processing unit is a parallelization unit and the initialization method is a reference-based context initialization method, the video encoding device may initialize the context model in the current processing unit by referring to a context state stored at a specified position of the parallelization unit corresponding to the current processing unit in a previously reconstructed reference picture.

The video encoding device sets the context initialization-enabling information based on the optimum initialization method (S1402). The context initialization-enabling information indicates whether to use the reference-based context initialization method for the context model. Further, the context initialization-enabling information may be a flag indicating whether to use the reference-based context initialization method or an index indicating one of the initialization methods.

The video encoding device encodes the context initialization-enabling information (S1404).

FIG. 15 is a flowchart of a method performed by the video decoding device for initializing a context model of CABAC, according to at least one embodiment of the present disclosure.

The video decoding device decodes context initialization-enabling information from the bitstream (S1500). Here, the context initialization-enabling information indicates whether to use a reference-based context initialization method for the context model in the current processing unit in the current picture. Further, the context initialization-enabling information may be a flag indicating whether to use the reference-based context initialization method or an index indicating one of the initialization methods.

The current processing unit may be the current picture or a parallelization unit within the current picture. The parallelization unit may be a slice, tile, CTU line, or VPDU within the current picture.

The video decoding device uses the context initialization-enabling information to determine an initialization method of the context model (S1502). Here, the initialization method may be a reference-based context initialization method or a QP-based context initialization method.

The video decoding device check whether the initialization method of the context model is a reference-based context initialization method (S1504).

When the initialization method is a reference-based context initialization method (Yes in S1504), the video decoding device uses the reference-based context initialization method to initialize the context model in the current processing unit (S1506). The video decoding device may initialize the context model in the current processing unit by using the context state at a predetermined location in a previously reconstructed reference picture.

When the current processing unit is a picture, and the initialization method is a reference-based context initialization method, the video decoding device may initialize the context model of the current picture by using the context state at a predetermined location in the previously reconstructed reference picture.

When the current processing unit is a parallelization unit and the initialization method is a reference-based context initialization method, the video decoding device may initialize the context model in the first parallelization unit in the current picture by using the context state at a predetermined location in the previously reconstructed reference picture.

Alternatively, if the current processing unit is a parallelization unit and the initialization method is a reference-based context initialization method, the video decoding device may initialize the context model in the current processing unit by referring to a context state stored at a specified position of the parallelization unit corresponding to the current processing unit in a previously reconstructed reference picture.

When the initialization method is a QP-based context initialization method (No in S1504), the video decoding device initializes the context model in the current processing unit by using the QP-based context initialization method (S1508). The video decoding device may initialize the context model in the current processing unit by using a predetermined, quantization parameter-based context state.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

1. A method performed by a video decoding device for initializing a context model of a context-based adaptive binary arithmetic coding, the method comprising:
decoding, from a bitstream, context initialization-enabling information that indicates whether to use a reference-based context initialization method for the context model in a current processing unit in a current picture;
determining an initialization method of the context model by using the context initialization-enabling information, wherein the initialization method is the reference-based context initialization method or a quantization parameter-based context initialization method;
checking whether the initialization method is the reference-based context initialization method; and
when the initialization method is the reference-based context initialization method, initializing the context model in the current processing unit by using a context state at a predetermined location in a previously reconstructed reference picture.

2. The method of claim 1, wherein the current processing unit is the current picture, or a parallelization unit within the current picture, and wherein the parallelization unit is a slice, a tile, a Coding Tree Unit line (CTU line), or a Virtual Pipeline Data Unit (VPDU) within the current picture.

3. The method of claim 1, wherein the context initialization-enabling information is represented as a flag indicating whether to use the context initialization method, or an index indicating one of initialization methods.

4. The method of claim 2, wherein initializing the context model includes:
when the current processing unit is the current picture and when the initialization method is the reference-based context initialization method, initializing the context model in the current picture by using the context state at the predetermined location in the previously reconstructed reference picture.

5. The method of claim 2, wherein initializing the context model includes:
when the current processing unit is the parallelization unit and when the initialization method is the reference-based context initialization method, initializing a context model in a first parallelization unit in the current picture by using the context state at the predetermined location in the previously reconstructed reference picture.

6. The method of claim 2, wherein initializing the context model includes:
when the current processing unit is the parallelization unit and when the initialization method is the reference-based context initialization method, initializing the context model in the current processing unit with reference to a context state stored in the previously reconstructed reference picture at a specified position of a parallelization unit corresponding to the current processing unit.

7. The method of claim 1, wherein initializing the context model includes:
when the initialization method is the quantization parameter-based context initialization method, initializing the context model in the current processing unit by using a predetermined and quantization parameter-based context state.

8. The method of claim 1, wherein the previously reconstructed reference picture is a reference picture that is being temporally closest to the current picture among reference pictures located in a same temporal layer with the current picture.

9. The method of claim 1, wherein initializing the context model includes:
when a current Group of Pictures (current GOP), which contains the current picture, uses an open GOP that references a previous GOP and when a picture having a same temporal layer with the current picture is not included in the current GOP, referencing the context state from a previously reconstructed picture included in the previous GOP and having a same temporal layer with the current picture.

10. The method of claim 1, wherein initializing the context model includes:
stopping from applying the reference-based context initialization method when the current picture is a non-reference picture.

11. A method performed by a video encoding device for initializing a context model of a context-based adaptive binary arithmetic coding, the method comprising:
obtaining context initialization-enabling information that indicates whether to use a reference-based context initialization method for the context model in a current processing unit in a current picture;
setting an initialization method of the context model by using the context initialization-enabling information, wherein the initialization method is the reference-based context initialization method or a quantization parameter-based context initialization method;
and
encoding the context initialization-enabling information;
wherein the method further comprises:
when the reference-based context initialization method is to be used, initializing the context model in the current processing unit by using a context state at a predetermined location in a previously reconstructed picture.

12. The method of claim 11, wherein the current processing unit is the current picture, or a parallelization unit within the current picture, and wherein the parallelization unit is a slice, a tile, a Coding Tree Unit line (CTU line), or a Virtual Pipeline Data Unit (VPDU).

13. The method of claim 11, wherein the context initialization-enabling information is represented as a flag indicating whether to use the context initialization method, or an index indicating one of initialization methods.

14. The method of claim 11, further comprising:
when the quantization parameter-based context initialization method is utilized, initializing the context model in the current processing unit by using a predetermined and quantization parameter-based context state.

15. A computer-readable recording medium storing a bitstream generated by a video encoding method, the video encoding method comprising, in initializing a context model:
obtaining context initialization-enabling information that indicates whether to use a reference-based context initialization method for the context model in a current processing unit in a current picture;
setting an initialization method of the context model by using the context initialization-enabling information, wherein the initialization method is the reference-based context initialization method or a quantization parameter-based context initialization method; and
encoding the context initialization-enabling information;
wherein the video encoding method further comprises:
when the reference-based context initialization method is to be used, initializing the context model in the current processing unit by using a context state at a predetermined location in a previously reconstructed picture.
